(19) United States
(12) Patent Application Publication
(10) Pub. No.: US 2021/0075620 A1
(43) Pub. Date: Mar. 11, 2021

(54) TIME-CONSTRAINED AUTHENTICATION

(71) Applicant: Honeywell International Inc., Morris Plains, NJ (US)

(72) Inventor: Kevin R. Driscoll, Maple Grove, MN (US)

(21) Appl. No.: 16/566,717

(22) Filed: Sep. 10, 2019

(51) Int. Cl. H04L 9/32

(52) U.S. Cl. CPC H04L 9/3236; H04L 7/0008

(57) ABSTRACT

In some examples, a device includes a receiver configured to receive a first message and receive a second message after receiving the first message, the first and second messages including first and second elements of a hash chain, respectively. The device also includes processing circuitry configured to apply a hash function to the second element of a hash chain to generate a hashed element and determine that the hashed element matches the first element in the hash chain. The processing circuitry is also configured to determine that the second message was received within an acceptable time window and determine that the second message is authentic in response to determining that the hashed element matches the first element in the hash chain and determining that the second message was received within the acceptable time window.

### TECHNICAL FIELD

This disclosure relates to communication systems.

### BACKGROUND

A man-in-the-middle (MITM) attack occurs when an attacker intercepts a message sent by a transmitter to a receiver. After intercepting the message, the MITM attacker can alter the message and forward the altered message to the receiver. The receiver can detect the MITM attack if the receiver receives the original, unaltered message and the altered message forwarded by the attacker. The receiver can compare the original message to the altered message to identify the difference in the messages. However, the attacker can jam or block the original message to prevent the original message from passing through to the receiver. If the receiver does not receive the original message, the receiver may not know that a MITM attack has occurred.

### SUMMARY

In general, this disclosure relates to systems, devices, and techniques for confirming the authenticity and integrity of a received message. A communication device receives a message including an element of a hash chain and verifies the authenticity of the message by applying a hash function to the element to generate a hashed element. The communication device then compares the hashed element to a previously received element of the hash chain. In addition, the communication device verifies that the message was received by the communication device within an acceptable time window. The communication device can confirm the authenticity of the message in response to determining that the hashed element matches the previously received element of the hash chain and in response to determining that the message was received by the communication device within the acceptable time window.

In some examples, a device includes a receiver configured to receive a first message including a first element of a hash chain and receive a second message after receiving the first message, where the second message includes a second element of the hash chain. The device also includes processing circuitry configured to apply a hash function to the second element of the hash chain to generate a hashed element and determine that the hashed element matches the first element of the hash chain. The processing circuitry is also configured to determine that the second message was received within an acceptable time window and determine that the second message is authentic in response to determining that the hashed element matches the first element of the hash chain and determining that the second message was received within the acceptable time window.

In some examples, a method includes receiving, by a receiver, a first message including a first element of a hash chain and receiving, by the receiver, a second message after receiving the first message, where the second message includes a second element of the hash chain. The method also includes applying, by processing circuitry coupled to the receiver, a hash function to the second element of the hash chain to generate a hashed element. The method further includes determining, by the processing circuitry, that the hashed element matches the first element of the hash chain and determining, by the processing circuitry, that the second message was received within an acceptable time window. The method includes determining, by the processing circuitry, that the second message is authentic in response to determining that the hashed element matches the first element of the hash chain and determining that the second message was received within the acceptable time window.

In some examples, a device includes a computer-readable medium having executable instructions stored thereon, configured to be executable by processing circuitry for causing the processing circuitry to receive a first message including a first element of a hash chain from a receiver and receive a second message from the receiver after receiving the first message, where the second message includes a second element of the hash chain. The instructions are also configured to cause the processing circuitry to apply a hash function to a second element of the hash chain to generate a hashed element and determine that the hashed element matches the first element of the hash chain. The instructions are further configured to cause the processing circuitry to determine that the second message was received within an acceptable time window and determine that the second message is authentic in response to determining that the hashed element matches the first element of the hash chain and determining that the second message was received within the acceptable time window.

The details of one or more examples of the disclosure are set forth in the accompanying drawings and the description below. Other features, objects, and advantages will be apparent from the description, drawings, and claims.

### BRIEF DESCRIPTION OF THE DRAWINGS

FIG. 1 is a conceptual block diagram of a man in the middle (MITM) attacker intercepting and altering a message, in accordance with some examples of this disclosure.

FIG. 2 is a flowchart illustrating an example technique implemented by devices in a communication system, in accordance with some examples of this disclosure.

FIG. 3 is a conceptual block diagram of a MITM attacker intercepting and altering a message in a broadcast network, in accordance with some examples of this disclosure.

FIG. 4 is diagram illustrating the transmission of hash elements and packets in a broadcast network, in accordance with some examples of this disclosure.

FIG. 5 is diagram illustrating the release times of hash elements with respect to interval boundaries, in accordance with some examples of this disclosure.

FIG. 6 is a flowchart illustrating an example process for determining whether a message is authentic, in accordance with some examples of this disclosure.

FIG. 7 is a flowchart illustrating an example process for broadcasting encrypted messages, in accordance with some examples of this disclosure.

FIG. 8 is a flowchart illustrating an example process for receiving and decrypting messages, in accordance with some examples of this disclosure.

### DETAILED DESCRIPTION

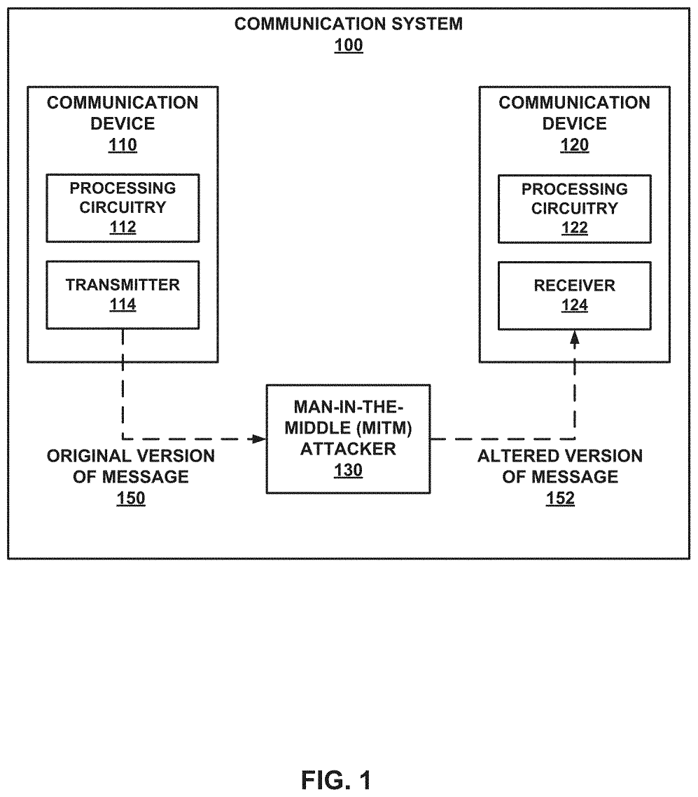

FIG. 1 is a conceptual block diagram of a man in the middle (MITM) attacker 130 intercepting and altering a message 150, in accordance with some examples of this disclosure. Communication system 100 includes communication devices 110 and 120 and MITM attacker 130. Communication devices 110 and 120 may be coupled together through a local area network, a wide area network, or the Internet. Communication system 100 may include a broadcast system such as a timed efficient stream loss-tolerant authentication (TESLA) system or an S/KEY system.

Communication device 110 includes processing circuitry 112 and transmitter 114. Communication device 120 includes processing circuitry 122 and receiver 124. Communication device 110 may be configured to broadcast message 150 to one or more receivers, including receiver 124. Message 150 includes an element of a hash chain. The hash chain can include two or more elements, where each element is the hashed version of a preceding element. For example, processing circuitry 112 can generate a first element in the hash chain by applying a hash function to a second element in the hash chain. Transmitter 114 will then send the hash element in the reverse order of the hash function being applied so that receiver 124 receives the first element before receiving the second element.

In some examples, communication device 110 transmits the first hash element, which is the last hash element to be created, to all receivers using some method that ensures integrity and authenticity of the first element. Each subsequent hash element received by communication device 120 and other receivers can be authenticated by hashing the hash element and comparing the hash result to a previously received and authenticated hash element.

Processing circuitry 112 causes transmitter 114 to transmit message 150 to receiver 124 at a second time. However, MITM attacker 130 intercepts and jams message 150 so that receiver 124 does not receive the original version of message 150. MITM attacker 130 generates message 152 by altering the contents of message 150. MITM attacker 130 then forwards message 152 to receiver 124. In examples in which receiver 124 receives both of messages 150 and 152, processing circuitry 122 can spot the replay (e.g., message 152) as an error. Therefore, MITM attacker 130 blocks message 150 so that message 152 appears to communication device 120 as the original (unaltered and/or undelayed) message.

In some examples, MITM attacker 130 does not alter message 150 but merely transmits the contents of message 150 as message 152 at a later time. MITM attacker 130 may use the delay in sending message 152 to imitate communication device 110 by sending other messages to receiver 124. For example, message 150 may include a hash element, a hash value, or a key that MITM attacker 130 can use to encrypt a packet. MITM attacker 130 can send the encrypted packet to receiver 124 before receiver 124 receives the hash value or key in message 152. If receiver 124 received the packet after message 150, processing circuitry 122 could identify the packet as inauthentic. Thus, in examples in which MITM attacker 130 jams the transmission of message 150 and sends the packet before receiver 124 receives message 152, receiver 124 may not identify the packet as inauthentic or message 152 as inauthentic.

Processing circuitry 122 can confirm the authenticity by applying a hash function to the hash element contained in message 152 to generate a hashed element and by comparing the hashed element to a hashed element that was previously transmitted by transmitter 114. The hash function can be an algorithm or function that, when applied to the hash element of message 152, generates an output referred to as a hashed element. Examples of hash functions that processing circuitry 122 can apply to the hash element in message 152 include secure hash algorithms, message-digest algorithms, hashing algorithms with variable length of output (HAVAL), or any other hashing algorithm that has the property of being “one-way”. That is, it would be extremely difficult to re-create the input to the hash function given only knowledge of the hash result.

However, even using the hash function, processing circuitry 122 may not recognize that message 152 has been altered by MITM attacker 130 because MITM attacker 130 can alter the contents of message 150 and/or delay message 150. The transmission time for message 150 may be shorter than the transmission time for message 152 because MITM attacker 130 introduces delay when MITM attacker 130 alters message 150. The use of a keyed hash value, such as a hash-based message authentication code (HMAC), may be useful for detecting a MITM attacker in a single-receiver system. In addition, public key cryptography may be useful for detecting a MITM attacker in a multiple-receiver system, but public key systems are expensive in terms of computation cycles and bandwidth.

In accordance with the techniques of this disclosure, processing circuitry 122 of communication device 120 determines whether message 152 is authentic by determining whether message 152 was received within an acceptable time window. By comparing the time of arrival of message 152 to an acceptable time window, processing circuitry 122 can identify or reject an MITM delay. The acceptable time window may be based on the known propagation delay and normal delay variances from transmitter 114 to the receiver 125 and a shared knowledge of time between transmitter 114 to the receiver 125.

By determining whether message 152 was received within the acceptable time window, processing circuitry 122 can spot a delay caused by MITM attacker 130. In examples in which processing circuitry 122 determines that receiver 124 did not receive message 152 within the acceptable time window, processing circuitry 122 can discard message 152 or notify other receivers that message 152 is not authentic. By discarding message 152 and not performing any actions that are detectable to MITM attacker 130, communication device 120 prevents MITM attacker 130 from learning that communication device 120 has detected the attack. In examples in which communication device 120 performs an observable action in response to detecting the attack, MITM attacker 130 can learn what attacks are detectable by communication device 120 and what attacks are not detectable. MITM attacker 130 can continue attacking communication device 120 until MITM attacker 130 detects that an attack has been successful.

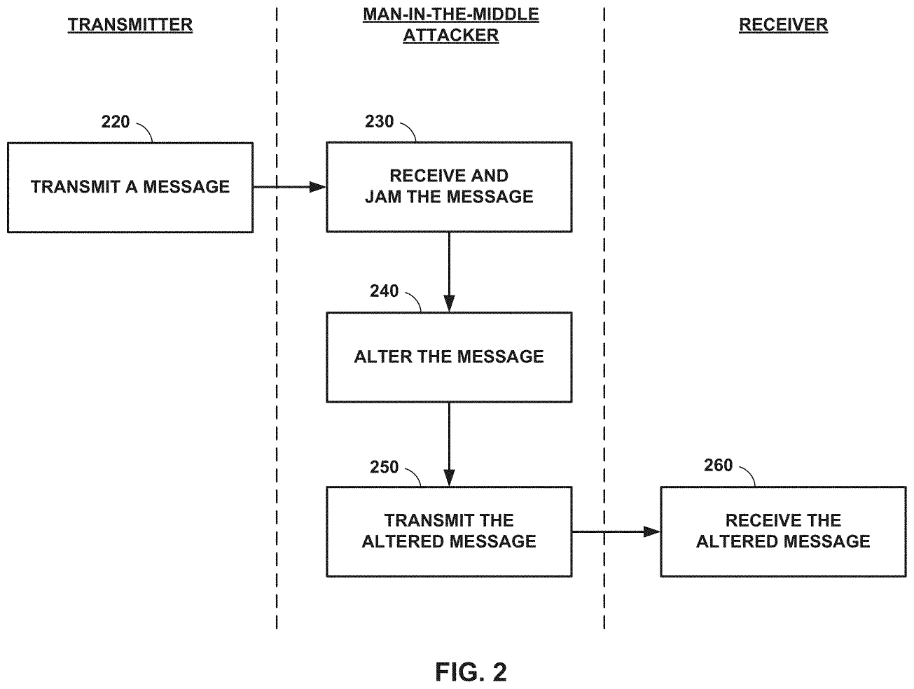

FIG. 2 is a flowchart illustrating an example technique implemented by devices in a communication system, in accordance with some examples of this disclosure. The example process of FIG. 2 is described with reference to communication system 100 shown in FIG. 1, although other components may exemplify similar techniques.

In some examples, processing circuitry 112 causes transmitter 114 to transmit a first message to communication device 120 before transmitting message 150. Receiver 124 then receives the message at a first time. The first message may include an indication of the acceptable time window for message 150. For example, the first message may include an indication that message 150 will be transmitted one hour after the transmission of the first message. Processing circuitry 122 can set the acceptable time window for message 150 as the expected arrival time for message 150 plus a buffer time to account for transmission time and jitter.

In the example of FIG. 2, processing circuitry 112 causes transmitter 114 to transmit message 150 to communication device 120 (220). MITM attacker 130 receives and jams message 150 so that receiver 124 does not receive message 150 (230). MITM attacker 130 alters message 150 to generate message 152 (240). MITM attacker 130 can alter message 150 by changing the contents of message 150. In the alternative, MITM attacker 130 can simply forward the contents of message 150 as message 152 at a later time.

MITM attacker 130 then transmits message 152 to communication device 120 (250). Receiver 124 receives message 152 at a second time after the first time (260). Processing circuitry 122 applies a hash function to the hash element included in message 152 to determine whether message 152 is authentic. The “authenticity” of message 152 refers to whether message 152 was transmitted by a stated sender or a trusted sender (e.g., transmitter 110), rather than an entity other than the stated or trusted sender (e.g., MITM attacker 130).

Existing authentication methods can have drawbacks, especially in resource-constrained environments. For Message Authentication Codes (MACs), all of the verifiers (e.g., receivers) have a shared cryptographic key, and each verifier can masquerade as any other verifier. Therefore, one captured node can compromise the whole network. Public Key cryptography has high bandwidth cost, very high processing cost, and long latency. Derivatives of S/Key and TESLA are susceptible to MITM attacks. Most protocols that use authentication methods other than S/KEY or TESLA require that the verifiers transmit something to the provee device. This transmission makes it difficult for the verifiers to support broadcast or multicast messages. It also makes it difficult for the verifiers to remain covert.

Communication security is an important design requirement, especially for connected devices such as internet-of-things (IoT) devices. Two important aspects of communication security are authentication and secrecy. For safety and security critical applications, authentication can be as important as secrecy or more important than secrecy. For example, embedded real-time control systems (e.g., internet of things and industrial internet of things) are resource (central processing unit (CPU) cycles, memory, bandwidth) constrained and have latency requirements. Using the techniques of this disclosure, communication devices can use fewer CPU cycles, bandwidth, and latency to ensure message authenticity. The techniques of this disclosure can allow for simple broadcast and multicast messaging and can allow for verifiers that cannot transmit or do not want to transmit (i.e., covert requirements). The techniques of this disclosure can also allow for lower cost communication systems and devices and may be used in a large range of applications.

For example, processing circuitry 122 can authenticate message 152 and solve the MITM vulnerabilities using tight time constraints. In some examples, communication system 100 is an S/Key or a TESLA derivative. Example details of an encryption for use by communication device 110 and 120 for message 150 in a TESLA derivative can be found in “BeepBeep: Embedded Real-Time Encryption” by Kevin Driscoll, published in Fast Software Encryption: 9^{th} International Workshop, which is incorporated by reference herein in its entirety. Using the BeepBeep algorithm or the Bleep algorithm for a TESLA-derivative system allows for authenticated encryption at a cost that is less than one percent of the CPU execution time of alternative methods, less than ten percent of the communication overhead, and less than one-tenth of one percent of the latency.

On a typical embedded-system processor (e.g., an ARM M3), the Bleep algorithm using the techniques of this disclosure is nearly one hundred times faster than AES-GCM, which translates into similarly lower power consumption. This implementation can also result in very low latency (e.g., as low as sub-bit-period) and very low jitter. The cryptographic overhead can be minimized or eliminated in the embedded system/Bleep implementation. The embedded system/Bleep implementation also simultaneously provides secrecy and integrity, and side-channel vulnerabilities can be avoided.

A security risk for embedded real-time systems is the compromise of a security flawed node in the network followed by a leap-frog attack across the network to a critical node. For example, an attacker can use a flawed car infotainment system to access the car's critical automotive systems via its CAN bus by masquerading as a critical node. By using authentication per this disclosure, a node cannot masquerade, thus stopping the advance of the attack. Because communication devices 110 and 120 are not using cryptographic keys in the example of FIG. 1, as is used in MACs, the security flawed node cannot provide the attacker with the MAC key. Additionally, the authentication mechanism per this disclosure does not adversely affect the real-time behavior of the system.

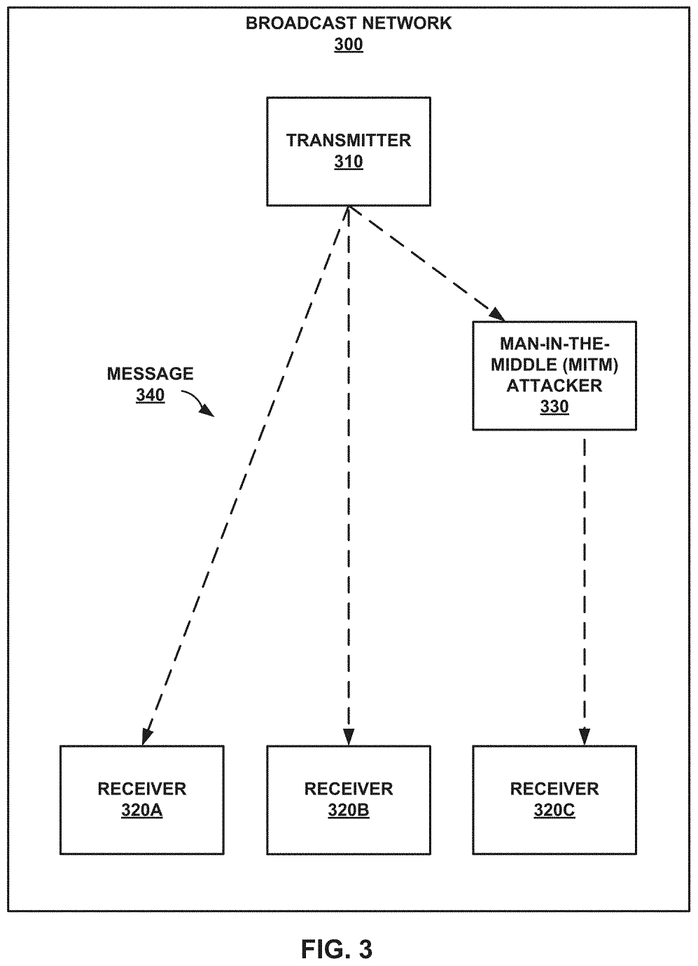

FIG. 3 is a conceptual block diagram of a MITM attacker 330 intercepting and altering a message 340 in a broadcast network 300, in accordance with some examples of this disclosure. Broadcast network 300 includes transmitter 310, receivers 320A-320C, and MITM attacker 330. Although FIG. 3 depicts three receivers, there may be one, two, or more than three receivers in a broadcast network. Transmitter 310 transmits message 340 to all of receivers 320A-320C in broadcast network 300. As described in more detail below, transmitter 310 may transmit hash elements or hash values that receivers 320A-320C can use to decrypt messages previously transmitted by transmitter 310. In some examples, broadcast network 300 may implement a TESLA protocol. A network based on TESLA does not need shared keys, but there are cryptographically secure hash values. There may also be authentication and secrecy protected communication during the initialization process to provide the initial hash value to the receivers.

MITM attacker 330 receives message 340 from transmitter 310 and may be able to jam the transmission of message 340 to one or more of receivers 320A-320C. MITM attacker 330 can intercept message 340 along the path of transmission from transmitter 310 to one or more of receivers 320A-320C. Receivers 320A-320C do not know the hash values until transmitter 310 releases each of the hash values. Thus, a compromised receiver does not lead to a compromised system. At any time, transmitter 310 is transmitting packets that are encrypted by a hash value that transmitter 310 has not released yet. When transmitter 310 releases this hash value, transmitter 310 then uses the next, currently unreleased hash value to encrypt packets for transmission.

Examples of broadcast network 300 include data-dissemination networks with a single transmitter, such as satellite broadcasts, wireless radio broadcasts, and internet protocol multicasts. An example of broadcast network 300 employing the techniques of this disclosure is a badge that continually sends out authentication codes in the form of hash chain elements. A user can wear the badge and approach a security door that includes a receiver. If the receiver verifies the identity of the badge, the door can unlock for the user. The authentication messages are one-way messages and the receiver can remain covert so that the user does not know which doors in a facility include a receiver or where the receivers are located. The user only knows which doors are open to the user and may not be able to distinguish between doors that are open to the public and door that only unlock after verifying an authentication code. A MITM attacker would not be able to intercept the authentication codes sent by the badge and use the transmission to gain access because a receiver will refrain from unlocking a door if the authentication code arrives outside of an acceptable time window.

Another example of broadcast network 300 employing the techniques of this disclosure is a covert receiver for verifying the authenticity of messages, such as the Identification Friend or Foe (IFF). In some examples, receivers 320A-320C can require all aircraft entering a certain air space to constantly broadcast a sequence of IFF hash chain element values for each respective aircraft. Receivers 320A-320C can be implemented as hidden anti-aircraft missile batteries on the ground. If one of receivers 320A-320C identifies an aircraft flying overhead that is not broadcasting an IFF signal, the missile battery can take an action against the aircraft such as outputting an alert or activating a weapon system. The positions of receivers 320A-320C can remain hidden and receivers 320A-320C do not give away their positions via radio transmissions. A MITM attacker would not be able to reuse a valid authentication code broadcast by a friendly aircraft because the receivers will detect the time delay introduced by the MITM attacker or by detecting an out-of-sequence or re-used hash chain element.

Another IFF example is a minefield with anti-vehicle mines or anti-personnel mines. Each friendly vehicle driving through or soldier walking through the minefield can broadcast a stream of IFF values. Each of receivers 320A-320C can be coupled to a mine. By being covert, the positions of the mines remain hidden and the mines do not give away the positions of the mines. The mines could use smaller batteries because the mines do not need transmitters. A MITM attacker would not be able to reuse a valid authentication code broadcast by an authorized user or vehicle because the receivers will detect the time delay introduced by the MITM attacker or by detecting an out-of-sequence or re-used hash chain element.

Other examples include cars going through gates in parking lots or driving on a toll road. The toll operator may include a receiver and the cars may include transmitters. If a car transmits messages that the receiver determines to be authentic, the car may be allowed to use the parking lot or the toll road. The foregoing examples may be especially well suited to the techniques of this disclosure because there is no jitter associated with line-of-sight or point-to-point communications.

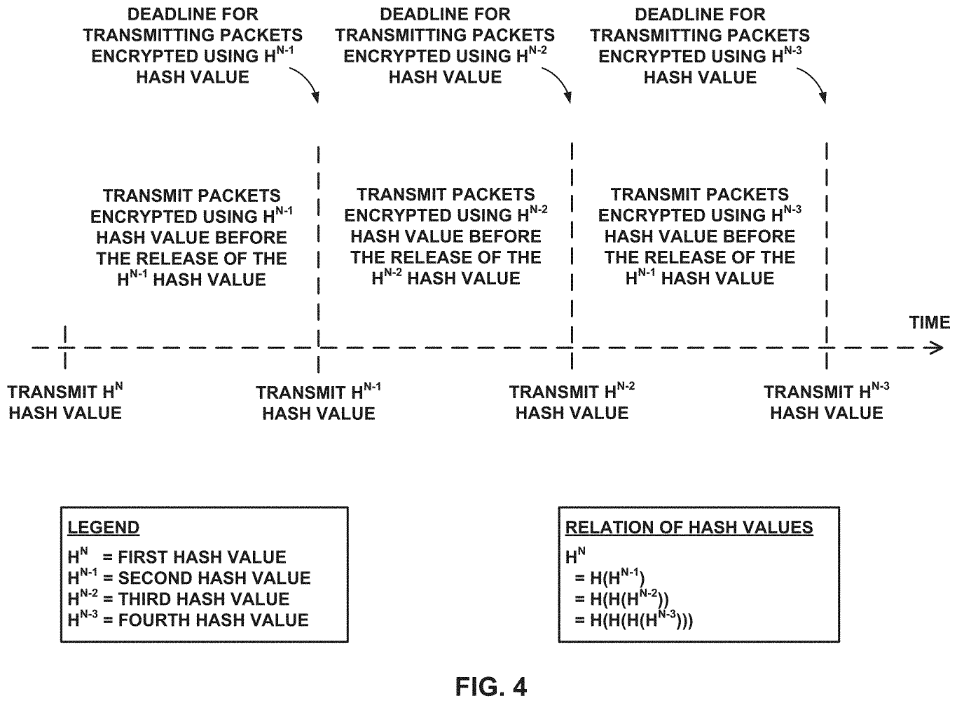

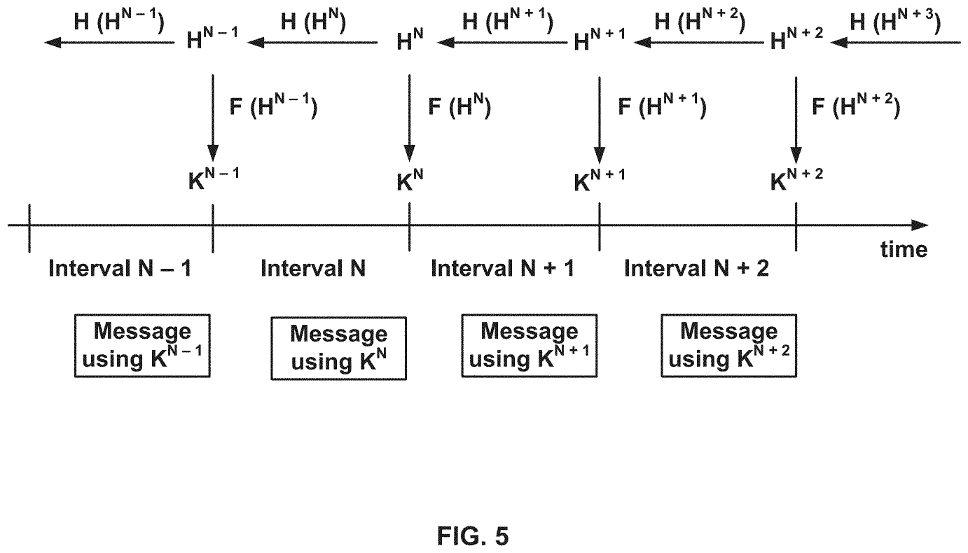

FIG. 4 is diagram illustrating the transmission of hash elements and packets in a broadcast network, in accordance with some examples of this disclosure. The example process of FIG. 4 is described with reference to broadcast network 300 shown in FIG. 3, although other components such as communication devices 110 and 120 shown in FIG. 1 may exemplify similar techniques. Both of FIGS. 4 and 5 are examples of periodic broadcasts that can be based on a schedule of message broadcasts.

In the example of FIG. 4, transmitter 310 first transmits the H^{N} hash value or hash element to receivers 320A-320C. The H^{N} hash value is an element of a hash chain that is based on the H^{N-1}, H^{N-2}, and H^{N-3} hash values. After transmitting the H^{N} hash value, transmitter 310 transmits packets that are encrypted using the H^{N-1} hash value. Receivers 320A-320C receive the packets that are encrypted using the H^{N-1} hash value before receivers 320A-320C receive the H^{N-1} hash value. The encryption can provide secrecy only, integrity/authentication only, or both secrecy and integrity/authentication depending on the algorithm used and the manner in which it is used.

Transmitter 310 then transmits the H^{N-1} hash value to receivers 320A-320C. The soonest expected time of transmission of the H^{N-1} hash value represents the deadline for transmitting packets that are encrypted using the H^{N-1} hash value. The releases of hash values occur at or approximately at the interval boundaries. Receivers 320A-320C may be configured to reject any messages encrypted using the H^{N-1} hash value that are received after the transmission of the H^{N-1} hash value. Receivers 320A-320C can verify the H^{N-1} hash value by applying the hash function to the H^{N-1} hash value to generate a hashed element, represented as H(H^{N-1}). To confirm the authenticity of the H^{N-1} hash value, receivers 320A-320C can compare the hashed element to the H^{N} hash value. If the hashed element matches the H^{N} hash value, receivers 320A-320C know that the H^{N-1} hash value is authentic because only transmitter 310 knows the hash values in reverse order.

Transmitter 310 knows the hash values in reverse order because transmitter 310 initially creates the hash values before transmitting the H^{N} hash value. In one example, each hash value or hash element is 160 bits long and transmitter 310 performs the hash function one billion times to generate one billion hash values. Although this example is computationally intensive for transmitter 310, receivers 320A-320C only have to store the previous hash value and perform the hash function once to confirm the authenticity of the next received hash value. To reduce the computation workload for each message, transmitter 310 can generate all the hash values at one time and store the generated hash values. As a compromise between computation workload and storage space, transmitter 310 could store just a subset of the hash values, for example, every 1000^{th} value. Transmitter 310 can regenerate the remaining hash values using the stored hash values as needed.

Transmitter 310 generates the N hash values starting with a secret initial value or key known only itself. In some examples, this initial value is created from a truly random source. Transmitter 310 can generate the hash values offline and/or before the broadcasting process begins. Transmitter 310 generates the H¹ hash value by applying the hash function to the initial value once. Transmitter 310 then generates the H² hash value by applying the hash function to the H² hash value, and so on until transmitter 310 has N hash values. Transmitter 310 releases the H^{N} hash value before releasing any of the other hash value. After receiving the H^{N} hash value, receivers 320A-320C do not know any of the other hash values because receivers 320A-320C cannot perform a reverse hash function. Thus, only transmitter 310 can encrypt packets using the H^{N-1} hash value until transmitter 310 broadcasts the H^{N-1} hash value.

When receiver 320A, or any other receiver, receives a packet encrypted using the H^{N-1} hash value, receiver 320A can store the packet until the release of the H^{N-1} hash value. After receiver 320A receives the H^{N-1} hash value, receiver 320A can verify the authenticity of the H^{N-1} hash value by applying the hash function to the H^{N-1} hash value and comparing the output of the hash function to the H^{N} hash value. In addition, receiver 320A can verify the authenticity of the H^{N-1} hash value based on whether receiver 320A received the H^{N-1} hash value within the acceptable time window. Receiver 320A can use the H^{N-1} hash value to decrypt the packets sent by transmitter 310 before the release of the H^{N-1} hash value. Receiver 320A can verify the authenticity of the packets by decrypting the packets because no entity other than transmitter 310 had access to the H^{N-1} hash value before the release of the H^{N-1} hash value by transmitter 310.

After transmitting the H^{N-1} hash value, transmitter 310 can transmit packets that are encrypted using the H^{N-2} hash value. The time of transmission of the H^{N-2} hash value represents the deadline for transmitting packets that are encrypted using the H^{N-2} hash value. Receivers 320A-320C may be configured to reject any messages encrypted using the H^{N-2} hash value that are received after the transmission of the H^{N-2} hash value.

After transmitting the H^{N-2} hash value, transmitter 310 can transmit packets that are encrypted using the H^{N-3} hash value. The time of transmission of the H^{N-3} hash value represents the deadline for transmitting packets that are encrypted using the H^{N-3} hash value. Receivers 320A-320C may be configured to reject any messages encrypted using the H^{N-3} hash value that are received after the transmission of the H^{N-3} hash value.

Receiver 320A can verify the authenticity of a hash value by determining whether the hash value was received within an acceptable time window. In some examples, receiver 320A can check whether the hash value was received within a threshold time duration after the previously received hash value. For hash values released every hour, receiver 320A can confirm that the hash value was received no more than one hour past the arrival of the previous hash value, plus an optional acceptable delay. Receiver 320A can determine an acceptable delay for a hash value based on an expected propagation delay for the hash value, a jitter for the expected propagation delay for the hash value, and/or a distance between receiver 320A and transmitter 310.

Receiver 320A can determine the expected propagation delay based on the distance using the rate of travel of the data over the transmission medium, as well as the expected number of hops along the travel path. Each hop may be associated with an average delay and a jitter. The jitter is the variance or deviation in the latency or the difference between the fastest and slowest possible propagation times. Receiver 320A can more easily spot MITM delay when there is low jitter because receiver 320A may determine a longer acceptable time window for situations with higher jitter. Line-of-sight or point-to-point transmission may have lower jitter than multi-hop transmissions.

In other words, if receiver 320A determines that message 340 took longer than normal propagation, then receiver 320A can determine that MITM attacker 330 intercepted or forged the message. The techniques of this disclosure allow receiver 320A to constrain the propagation time of message 340. Receiver 320A can verify the authenticity of message 340 based on either the time between messages (e.g., the time difference) or the time of arrival (e.g., for regular broadcasts).

Additionally or alternatively, receiver 320A can check whether the hash value was received at a predefined arrival time. Receiver 320A can determine the predefined arrival time based on a schedule of regular broadcasts (e.g., 1:00:00, 2:00:00, and so on). The messages received from transmitter 310 may include an indication of the predefined arrival times and/or the schedule of regular broadcasts. Otherwise, receiver 320A can follow a standard for the schedule of regular broadcasts, such as a certain number of transmissions per hour or per minute.

Receiver 320A can determine the acceptable time window based on the time of the clock tick when the transmission is expected plus the transmission delay or propagation delay plus two times the clock error. The clock error is the difference between the local clock used by receiver 320A and some defined ideal clock such as a Global Positioning System (GPS) clock or a network time protocol clock (NTP). Receiver 320A should synchronize the local clock to keep the clock error less than one quarter of the minimum MITM insertion delay.

Receiver 320A can synchronize the clock used by receiver 320A with the clock used by transmitter 310 or create some relationship between the two clocks. Receiver 320A can synchronize the clocks absolutely from an external source (e.g., GPS or NTP) using a synchronization algorithm so that the two clocks are tracking each other. Receiver 320A can also perform a relative synchronization, where transmitter 310 sends a message a set time after sending the previous message. Receiver 320A can synchronize the clocks based on a mutually perceived event. If both clocks are absolutely synchronized, receiver 320A checks for message 340 within a certain time window. If the clock synchronization is relative, receiver 320A can check for message 340 a certain time duration after the previous message. For example, the previous message may have included a statement such as “the next message will arrive in two hours.” Relative synchronization does not need regular time intervals or a globally perceived, absolute view of time.

Moreover, receiver 320A can verify the authenticity of a packet received during an interval by determining that the packet was received within an acceptable time window. The acceptable time window for a packet can be the time window ending when receiver 320A receives the hash value used to encrypt the packet. The acceptable time window for a packet can also be the time window ending at the expected transmission time or the arrival transmission time for the hash value used to encrypt the packet. Receiver 320A may impose the rule that a packet encrypted using a hash value must be received before the hash value arrives anywhere (e.g., before any of receivers 320A-320C receives the hash value). Receiver 320A may require that this order is preserved. MITM attacker 330 cannot forge the hash value because the reverse hash function is difficult or impossible to perform.

FIG. 5 is diagram illustrating the release times of hash values with respect to interval boundaries, in accordance with some examples of this disclosure. FIGS. 4 and 5 illustrate similar concepts, except that in FIG. 5 a function F is applied to the hash values to generate keys that are used for encryption, whereas FIG. 4 depicts transmitting the hash values without generating separate keys for transmission. The example process of FIG. 5 is described with reference to broadcast network 300 shown in FIG. 3, although other components such as communication devices 110 and 120 shown in FIG. 1 may exemplify similar techniques.

Transmitter 310 applies the hash function H to the hash value H^{N+3} to generate the hash values H^{N+2}, H^{N+1}, H^{N}, H^{N-1}, and so on. Transmitter 310 can generate the key K^{N-1} by applying the function F to H^{N-1}. In some examples, the function F may be a null function such that K^{N-1} equals H^{N-1}, so that transmitter 310 effectively sends the hash value H^{N-1} instead of a separate and distinct key F^{N-1}. During the interval N−1, transmitter 310 sends packets encrypted using K^{N-1} before sending the key K^{N-1} to receivers 320A-320C. Receivers 320A-320C can determine that the key K^{N-1} is not authentic if a MITM attacker intercepts and re-transmits the key K^{N-1} because of the time delay.

After releasing the key K^{N-1}, transmitter 310 sends messages encrypted using the key K^{N}. At the end of interval N, transmitter 310 releases the key K^{N} to receivers 320A-320C. The process continues with the keys K^{N+1} and K^{N+2}. If receiver 320A receives the key K^{N-1} after receiving the key K^{N} (e.g., in the wrong order), receiver 320A can determine that the key K^{N} is not authentic because the key K^{N} arrived outside of the acceptable time window. In some examples, the transmitter 310 releases each key by transmitting it to receivers 320A-320C. In some examples, keys released are not transmitted. Instead, upon receiving and authenticating a hash value, receivers 320A-320C can apply the function F to that hash value to re-create the corresponding encryption key used by the transmitter.

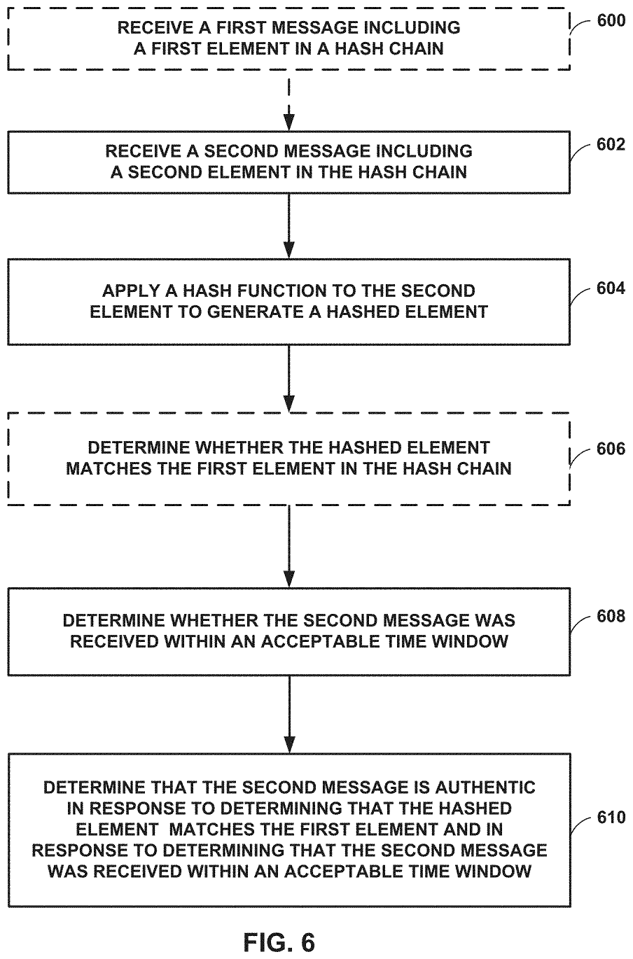

FIG. 6 is a flowchart illustrating an example process for determining whether a message is authentic, in accordance with some examples of this disclosure. The example process of FIG. 6 is described with reference to communication system 100 shown in FIG. 1, although other systems may exemplify similar techniques.

In the example of FIG. 6, communication device 120 optionally receives a first message including a first element in a hash chain (600). The first element may be all or a portion of the contents of the first message. Communication device 120 then receives message 152 after receiving the first message (602), where message 152 includes a second element of the hash chain. In some examples, the first element in a hash chain is conveyed to communication device 120 by some means other than the optional reception of a message, e.g., the first element in a hash chain can physically loaded into communication device 120 at time of manufacture or deployment. Processing circuitry 122 applies a hash function to the second hash element included in message 152 to generate a hashed element (604). Processing circuitry 122 optionally determines whether the hashed element matches the first element in the hash chain (606). MITM attacker 130 may have generated message 152 by altering message 150 such that processing circuitry 122 will not determine that message 152 is not authentic. In some examples, MITM attacker 130 may not alter message 150 but may delay the transmission of message 152 so that MITM attacker 130 can use the contents of message 150 to encrypt a packet. MITM attacker 130 may transmit the packet to communication device 120. After transmitting message 152 to communication device 120, MITM attacker 130 can transmit message 152 to communication device 120.

In the example of FIG. 6, processing circuitry 122 also determines whether receiver 124 received message 152 within an acceptable time window (608). Processing circuitry 122 can determine the acceptable time window by adding a threshold time duration to the arrival time of the first message. Processing circuitry 122 may determine that the delay introduced by MITM attacker 130 causes the arrival time of message 152 to be outside of the acceptable time window. Processing circuitry 122 then determines that message 152 is authentic in response to determining that the hashed element matches the first element in the hash chain and in response to determining that message 152 was received within an acceptable time window (610). Because of the delay caused by MITM attacker 130, processing circuitry 122 can identify message 152 as inauthentic.

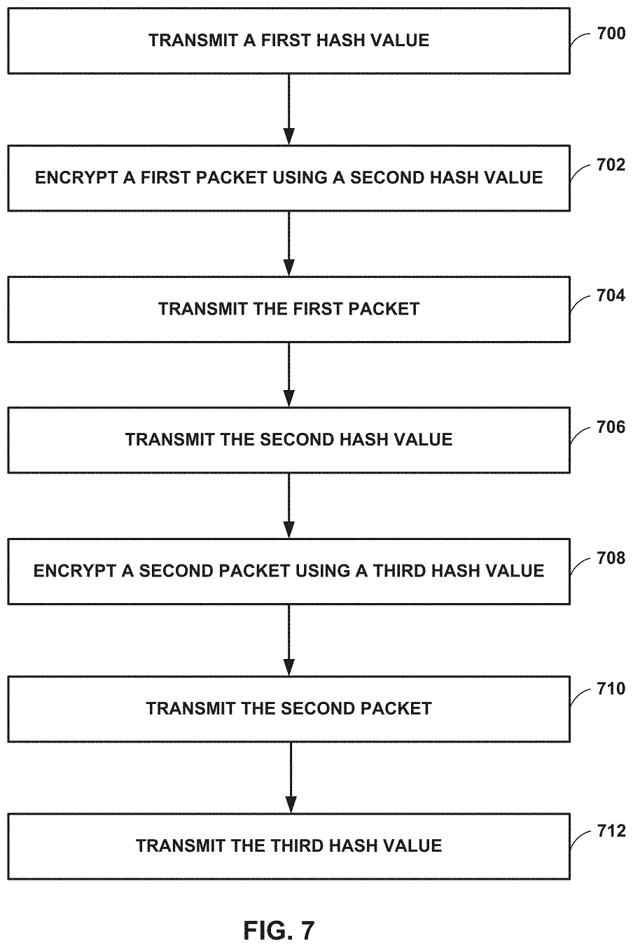

FIG. 7 is a flowchart illustrating an example process for broadcasting encrypted messages, in accordance with some examples of this disclosure. The example process of FIG. 7 is described with reference to transmitter 310 shown in FIG. 3, although other transmitters may exemplify similar techniques.

In the example of FIG. 7, transmitter 310 transmits a first hash value to receivers 320A-320C (700). Before transmitting the first hash value, transmitter 310 generate the hash values in the following way. Transmitter 310 can apply a hash function to a fourth hash value to generate a third hash value. Transmitter 310 can apply the hash function to the third hash value to generate a second hash value. Transmitter 310 can apply the hash function to the second hash value to generate the first hash value.

In the example of FIG. 7, transmitter 310 then encrypts a first packet using the second hash value (702) and transmits the first packet to receivers 320A-320C (704). After transmitting the first packet, transmitter 310 transmits the second hash value (706). Receivers 320A-320C can verify the authenticity of the second hash value by applying the hash function to the second hash value and comparing the output of the hash function to the first hash value. Receivers 320A-320C can also decrypt the first packet using the second hash value.

In the example of FIG. 7, transmitter 310 transmits encrypts a second packet using the third hash value (708) and transmits the second packet to receivers 320A-320C (710). After transmitting the second packet, transmitter 310 transmits the third hash value (712). Transmitter 310 can use the third hash value as a MAC key by sending MACed messages (e.g., the second packet) before sending the third hash value.

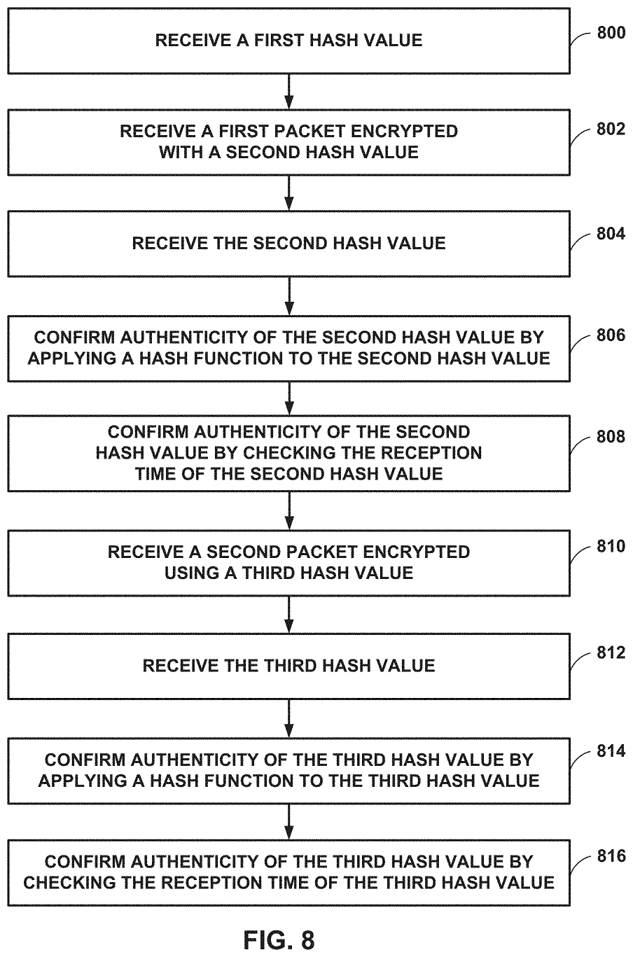

FIG. 8 is a flowchart illustrating an example process for receiving and decrypting messages, in accordance with some examples of this disclosure. The example process of FIG. 8 is described with reference to receiver 320C shown in FIG. 3, although other transmitters may exemplify similar techniques.

In the example of FIG. 8, receiver 320C receives a first hash value from transmitter 310 (800). Receiver 320C cannot independently generate the second hash value because receiver 320C cannot reverse the hash function. After receiving the first hash value, receiver 320C receives a first packet encrypted with a second hash value (802). Receiver 320C later receives the second hash value (804).

Receiver 320C confirms the authenticity of the second hash value by applying the hash function to the second hash value (806). Receiver 320C can compare the output of the hash function to the first hash value. Receiver 320C can verify the authenticity of the second hash value by determining that the output of the hash function matches the first hash value. Receiver 320C also confirms the authenticity of the second hash value by checking the reception time of the second hash value (808). In response to determining that the second hash value was received within an acceptable time window, receiver 320C can determine that the second hash value is authentic. In response to determining that the second hash value was received outside of an acceptable time window, receiver 320C can determine that the second hash value is not authentic.

In examples in which MITM attacker 330 intercepts and jams message 340 (e.g., the second hash value), receiver 320C may receive a delayed version of message 340 from MITM attacker 330. If receiver 320C only applies the hash function to the hash element included in message 340, receiver 320C may not be able to identify that message 340 is not authentic. However, if receiver 320C also checks the arrival time of the delayed version, receiver 320C can determine that the delayed version of message 340 is not authentic because the actions of MITM attacker 330 may have caused a sufficient delay for message 340.

MITM attacker 330 may cause the delay for the second hash value in order to send a packet encrypted using the second hash value after the expected arrival time for the second hash value. MITM attacker 330 needs the second hash value to encrypt a packet using the second hash value, and receiver 320C may not identify packets encrypted using the second hash value that arrive after the second hash value as not authentic. Therefore, receiver 320C can determine that the packet is not authentic by determining that the packet was received outside of the acceptable time window for packets encrypted using the second hash value. Receiver 320C may be configured to determine that the acceptable time window for packets encrypted using the second hash value ends at the expected arrival time for the second hash value, or at the earliest expected arrival time for the second hash value.

After receiving the second hash value, receiver 320C receives a second packet encrypted with a third hash value (810). Receiver 320C later receives the third hash value (812). Receiver 320C confirms the authenticity of the third hash value by applying the hash function to the third hash value (814). Receiver 320C can verify the authenticity of the third hash value by determining that the output of the hash function matches the second hash value. Receiver 320C also confirms the authenticity of the third hash value by checking the reception time of the third hash value (816). In response to determining that the third hash value was received within an acceptable time window, receiver 320C can determine that the third hash value is authentic.

The following numbered examples demonstrate one or more aspects of the disclosure.

Example 1. A method includes receiving, by a receiver, a first message including a first element of a hash chain and receiving, by the receiver, a second message after receiving the first message, wherein the second message includes a second element of the hash chain. The method also includes applying, by processing circuitry coupled to the receiver, a hash function to the second element of the hash chain to generate a hashed element. The method further includes determining, by the processing circuitry, that the hashed element matches the first element of the hash chain and determining, by the processing circuitry, that the second message was received within an acceptable time window. The method includes determining, by the processing circuitry, that the second message is authentic in response to determining that the hashed element matches the first element of the hash chain and determining that the second message was received within the acceptable time window.

Example 2. The method of example 1, where receiving the first message includes receiving the first message at a first time, receiving the second message includes receiving the second message at a second time, and determining that the second message was received within the acceptable time window includes determining that a difference between the first time and the second time is less than a threshold time duration.

Example 3. The method of examples 1-2 or any combination thereof, where determining that the second message was received within the acceptable time window includes determining that the second message was received no more than a threshold time duration after a predefined arrival time.

Example 4. The method of example 3, further including determining the predefined arrival time based on a schedule of message transmissions.

Example 5. The method of examples 1-4 or any combination thereof, further including determining an expected arrival time for the second message based on the first message. Determining that the second message was received within the acceptable time window includes determining that the second message was received no more than a threshold time duration after an arrival time indicated by the first message.

Example 6. The method of examples 1-5 or any combination thereof, further including determining the expected arrival time for the second message based on data in the first message indicating the expected arrival time for the second message.

Example 7. The method of examples 1-6 or any combination thereof, where determining that the second message was received within the acceptable time window includes determining that the second message was received within an acceptable delay after an expected arrival time or an expected transmission time.

Example 8. The method of examples 1-7 or any combination thereof, where the acceptable delay is based on an expected propagation delay for the second message.

Example 9. The method of examples 1-8 or any combination thereof, where the acceptable delay is based on a jitter for an expected propagation delay for the second message.

Example 10. The method of examples 1-9 or any combination thereof, where the acceptable delay is based on a distance between the receiver and a transmitter that transmitted the first and second messages.

Example 11. The method of examples 1-10 or any combination thereof, further including synchronizing a clock coupled to the processing circuitry with a clock of a transmitter that transmitted the first and second messages. The method also includes determining the acceptable time window based on the clock coupled to the processing circuitry.

Example 12. The method of examples 1-11 or any combination thereof, further including synchronizing a clock coupled to the processing circuitry using Global Navigation Satellite System or Network Time Protocol and determining the acceptable time window based on the clock coupled to the processing circuitry.

Example 13. The method of examples 1-12 or any combination thereof, where the acceptable time window is a first acceptable time window, the method further including receiving a third message after receiving the second message, determining that the third message was received outside of a second acceptable time window, and determining that the third message is inauthentic in response to determining that the third message was received outside of the second acceptable time window.

Example 14. The method of examples 1-13 or any combination thereof, further including sending a challenge message to the transmitter that transmitted the first message, where determining that the second message was received within the acceptable time window includes determining that the second message was received within a threshold time duration after sending the challenge message.

Example 15. The method of examples 1-14 or any combination thereof, where the hashed element is a first hashed element, and the method further includes receiving a third message including a third element in the hash chain after receiving the second message and receiving a fourth message after receiving the third message, wherein the fourth message includes a fourth element in the hash chain.

Example 16. The method of examples 1-15 or any combination thereof, further including applying the hash function to the fourth element to generate a second hashed element and determining that the second hashed element matches the second element in the hash chain.

Example 17. The method of examples 1-16 or any combination thereof, further including determining that the fourth message is inauthentic in response to determining that the second hashed element matches the second element in the hash chain.

Example 18. The method of examples 1-17 or any combination thereof, further including discarding the second message in response to determining that the second message is inauthentic.

Example 19. A device includes a receiver configured to receive a first message including a first element of a hash chain and receive a second message after receiving the first message, wherein the second message includes a second element of the hash chain. The device also includes processing circuitry configured to apply a hash function to the second element of the hash chain to generate a hashed element and determine that the hashed element matches the first element of the hash chain. The processing circuitry is also configured to determine that the second message was received within an acceptable time window and determine that the second message is authentic in response to determining that the hashed element matches the first element of the hash chain and determining that the second message was received within the acceptable time window.

Example 20. The device of example 19, where the processing circuitry is configured to perform the method of examples 1-18 or any combination thereof.

Example 21. The device of examples 19-20 or any combination thereof, where the receiver is configured to receive the first message at a first time and receive the second message at a second time.

Example 22. The device of examples 19-21 or any combination thereof, where the processing circuitry is configured to determine that the second message was received within the acceptable time window by determining that a difference between the first time and the second time is less than a threshold time duration.

Example 23. The device of examples 19-22 or any combination thereof, where the processing circuitry is configured to determine that the second message was received within the acceptable time window by determining that the second message was received no more than a threshold time duration after a predefined arrival time.

Example 24. The device of examples 19-23 or any combination thereof, where the processing circuitry is further configured to determine the predefined arrival time based on a schedule of message transmissions.

Example 25. The device of examples 19-24 or any combination thereof, where the processing circuitry is further configured to determine an expected arrival time for the second message based on the first message.

Example 26. The device of examples 19-25 or any combination thereof, where the processing circuitry is configured to determine that the second message was received within the acceptable time window by determining that the second message was received no more than a threshold time duration after an arrival time indicated by the first message.

Example 27. The device of examples 19-26 or any combination thereof, where the processing circuitry is configured to determine the expected arrival time for the second message based on data in the first message indicating the expected arrival time for the second message.

Example 28. The device of examples 19-27 or any combination thereof, where the processing circuitry is configured to determine that the second message was received within the acceptable time window by determining that the second message was received within an acceptable delay after an expected arrival time or an expected transmission time.

Example 29. The device of examples 19-28 or any combination thereof, where the processing circuitry is configured to determine the acceptable delay based on an expected propagation delay for the second message.

Example 30. The device of examples 19-29 or any combination thereof, wherein the processing circuitry is configured to determine the acceptable delay based on a jitter for an expected propagation delay for the second message.

Example 31. The device of examples 19-30 or any combination thereof, where the processing circuitry is configured to determine the acceptable delay based on a distance between the receiver and a transmitter that transmitted the first and second messages.

Example 32. The device of examples 19-31 or any combination thereof, where processing circuitry is further configured to synchronize a clock coupled to the processing circuitry with a clock of a transmitter that transmitted the first and second messages.

Example 33. The device of examples 19-32 or any combination thereof, where processing circuitry is further configured to determine the acceptable time window based on the clock coupled to the processing circuitry.

Example 34. The device of examples 19-33 or any combination thereof, where processing circuitry is further configured to synchronize a clock coupled to the processing circuitry using Global Navigation Satellite System or Network Time Protocol.

Example 35. The device of examples 19-34 or any combination thereof, where processing circuitry is further configured to determine the acceptable time window based on the clock coupled to the processing circuitry.

Example 36. A device includes a computer-readable medium having executable instructions stored thereon, configured to be executable by processing circuitry for causing the processing circuitry to receive a first message from a receiver and receive a second message from the receiver after receiving the first message, where the first and second messages include first and second hash elements of a hash chain, respectively. The instructions are also configured to cause the processing circuitry to apply a hash function to a second element of the hash chain to generate a hashed element and determine that the hashed element matches the first element of the hash chain. The instructions are further configured to cause the processing circuitry to determine that the second message was received within an acceptable time window and determine that the second message is authentic in response to determining that the hashed element matches the first element of the hash chain and determining that the second message was received within the acceptable time window.

Example 37. The device of example 36, where the processing circuitry is configured to perform the method of examples 1-18 or any combination thereof.

Example 38. A system includes means for receiving a first message and receiving a second message after receiving the first message, where the first and second messages include first and second hash elements of a hash chain, respectively. The system also includes means for applying a hash function to a second element in the hash chain to generate a hashed element and means for determining that the hashed element matches the first element in the hash chain. The system further includes means for determining that the second message was received within an acceptable time window and means for determining that the second message is authentic in response to determining that the hashed element matches the first element in the hash chain and determining that the second message was received within the acceptable time window.

Example 39. The device of example 38, further including means for performing the method of examples 1-18 or any combination thereof.

The disclosure contemplates computer-readable storage media including instructions to cause a processor to perform any of the functions and techniques described herein. The computer-readable storage media may take the example form of any volatile, non-volatile, magnetic, optical, or electrical media, such as a random access memory (RAM), read-only memory (ROM), non-volatile RAM (NVRAM), electrically erasable programmable ROM (EEPROM), or flash memory. The computer-readable storage media may be referred to as non-transitory. A computing device may also contain a more portable removable memory type to enable easy data transfer or offline data analysis.

The techniques described in this disclosure, including those attributed to communication devices 110 and 120, processing circuitry 112 and 122, transmitters 114 and 310, receivers 124 and 320A-320C, and various constituent components, may be implemented, at least in part, in hardware, software, firmware or any combination thereof. Such hardware, software, and/or firmware may support simultaneous or non-simultaneous bi-directional messaging and may act as an encrypter in one direction and a decrypter in the other direction. For example, various aspects of the techniques may be implemented within one or more processors, including one or more microprocessors, digital signal processors (DSPs), application-specific integrated circuits (ASICs), field-programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

As used herein, the term “circuitry” refers to an ASIC, an electronic circuit, a processor (shared, dedicated, or group) and memory that execute one or more software or firmware programs, a combinational logic circuit, or other suitable components that provide the described functionality. The term “processing circuitry” refers one or more processors distributed across one or more devices. For example, “processing circuitry” can include a single processor or multiple processors on a device. “Processing circuitry” can also include processors on multiple devices, wherein the operations described herein may be distributed across the processors and devices.

Such hardware, software, firmware may be implemented within the same device or within separate devices to support the various operations and functions described in this disclosure. For example, any of the techniques or processes described herein may be performed within one device or at least partially distributed amongst two or more devices, such as between communication devices 110 and 120, processing circuitry 112 and 122, transmitters 114 and 310, and/or receivers 124 and 320A-320C. Such hardware may support simultaneous or non-simultaneous bi-directional messaging and may act as an encrypter in one direction and a decrypter in the other direction. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in an article of manufacture including a non-transitory computer-readable storage medium encoded with instructions. Instructions embedded or encoded in an article of manufacture including a non-transitory computer-readable storage medium encoded, may cause one or more programmable processors, or other processors, to implement one or more of the techniques described herein, such as when instructions included or encoded in the non-transitory computer-readable storage medium are executed by the one or more processors.

In some examples, a computer-readable storage medium includes non-transitory medium. The term “non-transitory” may indicate that the storage medium is not embodied in a carrier wave or a propagated signal. In certain examples, a non-transitory storage medium may store data that can, over time, change (e.g., in RAM or cache). Elements of devices and circuitry described herein, including, but not limited to, communication devices 110 and 120, processing circuitry 112 and 122, transmitters 114 and 310, and/or receivers 124 and 320A-320C, may be programmed with various forms of software. The one or more processors may be implemented at least in part as, or include, one or more executable applications, application modules, libraries, classes, methods, objects, routines, subroutines, firmware, and/or embedded code, for example.

Various examples of the disclosure have been described. Any combination of the described systems, operations, or functions is contemplated. These and other examples are within the scope of the following claims.

What is claimed is:

1. A device comprising:
a receiver configured to:
receive a first message including a first element of a hash chain; and
receive a second message after receiving the first message, wherein the second message includes a second element of the hash chain; and
processing circuitry configured to:
apply a hash function to the second element of the hash chain to generate a hashed element;
determine that the hashed element matches the first element in the hash chain;
determine that the second message was received within an acceptable time window; and
determine that the second message is authentic in response to:
determining that the hashed element matches the first element in the hash chain; and
determining that the second message was received within the acceptable time window.

2. The device of claim 1, wherein the receiver is configured to:
receive the first message at a first time; and
receive the second message at a second time,
wherein the processing circuitry is configured to determine that the second message was received within the acceptable time window by determining that a difference between the first time and the second time is less than a threshold time duration.

3. The device of claim 1, wherein the processing circuitry is configured to determine that the second message was received within the acceptable time window by determining that the second message was received no more than a threshold time duration after a predefined arrival time.

4. The device of claim 3, wherein the processing circuitry is further configured to determine the predefined arrival time based on a schedule of message transmissions.

5. The device of claim 1,
wherein the processing circuitry is further configured to determine an expected arrival time for the second message based on the first message, and
wherein the processing circuitry is configured to determine that the second message was received within the acceptable time window by determining that the second message was received no more than a threshold time duration after an arrival time indicated by the first message.

6. The device of claim 5, wherein the processing circuitry is configured to determine the expected arrival time for the second message based on data in the first message indicating the expected arrival time for the second message.

7. The device of claim 1, wherein the processing circuitry is configured to determine that the second message was received within the acceptable time window by determining that the second message was received within an acceptable delay after an expected arrival time or an expected transmission time.

8. The device of claim 7, wherein the processing circuitry is configured to determine the acceptable delay based on an expected propagation delay for the second message.

9. The device of claim 7, wherein the processing circuitry is configured to determine the acceptable delay based on a jitter for an expected propagation delay for the second message.

10. The device of claim 7, wherein the processing circuitry is configured to determine the acceptable delay based on a distance between the receiver and a transmitter that transmitted the first and second messages.

11. The device of claim 1, wherein the processing circuitry is further configured to:
synchronize a clock coupled to the processing circuitry with a clock of a transmitter that transmitted the first and second messages; and
determine the acceptable time window based on the clock coupled to the processing circuitry.

12. The device of claim 1, wherein the processing circuitry is further configured to:
synchronize a clock coupled to the processing circuitry using Global Navigation Satellite System or Network Time Protocol; and
determine the acceptable time window based on the clock coupled to the processing circuitry.

13. A method comprising:
receiving, by a receiver, a first message including a first element of a hash chain;
receiving, by the receiver, a second message after receiving the first message, wherein the second message includes a second element of the hash chain;
applying, by processing circuitry coupled to the receiver, a hash function to the second element of the hash chain to generate a hashed element;
determining, by the processing circuitry, that the hashed element matches the first element of the hash chain;
determining, by the processing circuitry, that the second message was received within an acceptable time window; and
determining, by the processing circuitry, that the second message is authentic in response to:
determining that the hashed element matches the first element of the hash chain; and
determining that the second message was received within the acceptable time window.

14. The method of claim 13,
wherein receiving the first message comprises receiving the first message at a first time,
wherein receiving the second message comprises receiving the second message at a second time, and
wherein determining that the second message was received within the acceptable time window comprises determining that a difference between the first time and the second time is less than a threshold time duration.

15. The method of claim 13, further comprising determining the predefined arrival time based on a schedule of message transmissions,
wherein determining that the second message was received within the acceptable time window comprises determining that the second message was received no more than a threshold time duration after a predefined arrival time.

16. The method of claim 13, further comprising determining an expected arrival time for the second message based on the first message,
wherein determining that the second message was received within the acceptable time window comprises determining that the second message was received no more than a threshold time duration after an arrival time indicated by the first message.

17. The method of claim 13, wherein determining that the second message was received within the acceptable time window comprises determining that the second message was received within an acceptable delay after an expected arrival time or an expected transmission time.

18. A device includes a computer-readable medium having executable instructions stored thereon, configured to be executable by processing circuitry for causing the processing circuitry to:
receive a first message from a receiver, wherein the first message includes a first element of a hash chain;
receive a second message from the receiver after receiving the first message, wherein the second message includes a second element of the hash chain;
apply a hash function to the second element of the hash chain to generate a hashed element;
determine that the hashed element matches the first element in the hash chain;
determine that the second message was received within an acceptable time window; and
determine that the second message is authentic in response to:
determining that the hashed element matches the first element in the hash chain; and
determining that the second message was received within the acceptable time window.

19. The device of claim 18, wherein the instructions are further configured for causing the processing circuitry to determine the predefined arrival time based on a schedule of message transmissions,
wherein the instructions to determine that the second message was received within the acceptable time window comprise instructions to determine that the second message was received no more than a threshold time duration after a predefined arrival time.

20. The device of claim 18, wherein the instructions are further configured for causing the processing circuitry to determine an expected arrival time for the second message based on the first message,
wherein the instructions to determine that the second message was received within the acceptable time window comprise instructions to determine that the second message was received no more than a threshold time duration after an arrival time indicated by the first message.
